(19) United States
(12) Patent Application Publication
(10) Pub. No.: US 2006/0099949 A1
(43) Pub. Date: May 11, 2006

(54) Handover system and method in heterogeneous network

(75) Inventors: Heung-Chul Jung, Suwon-si (KR); Sang-Jun Moon, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/267,204

(22) Filed: Nov. 7, 2005

(30) Foreign Application Priority Data
Nov. 5, 2004 (KR) 2004-90055

(51) Int. Cl. H04Q 7/20

(52) U.S. Cl. 455/436

(57) ABSTRACT

A handover system and method in a heterogeneous network are provided. The handover system includes a first network for providing a radio resource using a first radio frequency bandwidth. A first apparatus of a cellular network is connected to the first network through a wired network. A mobile station accesses the cellular network through a tunnel established with the first apparatus using the radio resource provided from the first network or accesses the cellular network using a radio resource provided from the cellular network, sets up a new path by a handover when the handover is needed, and accesses the cellular network through the new path.

### CLAIM OF PRIORITY

This application makes reference to, incorporates the same herein, and claims all benefits accruing under 35 U.S.C. §1 19(a) from an application entitled HANDOVER SYSTEM AND METHOD IN HETEROGENEOUS NETWORK filed in the Korean Intellectual Property Office on Nov. 5, 2004 and there duly assigned Serial No. 10-2004-0090055.

### BACKGROUND OF THE INVENTION

1. Field of the Invention

The present invention relates to a handover system and method in a heterogeneous wireless network in which a mobile station accesses a cellular communication network via the heterogeneous wireless network to be provided with a cellular service, thereby guaranteeing mobility of the mobile station.

2. Description of the Related Art

As recent communication technology becomes more and more ubiquitous, there is a need for technology for interworking different communication networks. However, there has been a difficulty in interworking different types of networks because they use, for example, different frequency bands. In order to solve the problem, a heterogeneous network interworking method which connects a cellular network and a different type network using different communication technology from the cellular network via a tunnel has been suggested. The heterogeneous network interworking method described above suggests only tunnel setting between the cellular network and the different type communication network, and it does not suggest a method for providing a mobile station which accesses the heterogeneous network using the tunnel with mobility within the network.

Guaranteeing the mobility of the mobile station is very important to a wireless communication network. Thus, in order to efficiently perform interworking between the heterogeneous networks, there is a need for providing the mobile station with the mobility to freely move between the heterogeneous networks.

### SUMMARY OF THE INVENTION

It is, therefore, an objective of the present invention to provide a handover system and method in a heterogeneous wireless network in which mobility of a mobile station is guaranteed between different types of communication networks.

It is another object of the present invention to provide a handover system and method in a heterogeneous wireless network in which mobility of a mobile station is guaranteed between different radio frequency bands of a heterogeneous network.

It is another object of the present invention to provide a handover system and method in a heterogeneous network in which a cellular network is interworked with a different type network through a tunnel established between a mobile station and the cellular network.

According to an aspect to the present invention, there is provided a handover system in a heterogeneous network, comprising a first network for providing a radio resource using a first radio frequency bandwidth. A first apparatus of a cellular network is connected to the first network through a wired network. A mobile station accesses the cellular network through a tunnel established with the first apparatus using the radio resource provided from the first network or accesses the cellular network using a radio resource provided from the cellular network, sets up a new path by a handover when the handover is needed, and accesses the cellular network through the new path.

According to another aspect to the present invention, there is provided a handover system in a heterogeneous network in which a cellular network is interworked with a first network through a tunnel established between a mobile station and an eBTS of the cellular network. The handover system comprises a mobile station for requesting a handover when it is determined that the handover is needed. An eBTS sets up a new path by establishing the tunnel with the mobile station, and transmits/receives data to/from the mobile station through the new path when receiving a tunnel establishment request for the handover from the mobile station.

According to still another aspect to the present invention, there is provided a handover system in a heterogeneous network in which a cellular network is interworked with a first network through a tunnel established between a mobile station and an eBSC of the cellular network. The handover system comprises a mobile station for requesting a handover when it is determined that a handover is needed. An eBSC sets up a new path by establishing the tunnel with the mobile station, and transmits/receives data to/from the mobile station through the new path, when receiving a tunnel establishment request for the handover from the mobile station.

According to yet another aspect to the present invention, there is provided a handover method in a heterogeneous network in which a cellular network is connected with a first network through a tunnel. The method comprises determining, at a mobile station, whether to handover. A tunnel connected to the cellular network through the first network is established to set up a new path used to transmit data after the handover. Date is transmitted/received to/from the cellular network through the new path.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which:

FIG. 1 is a schematic block diagram of a mobile station according to an embodiment of the present invention;

FIG. 2 is a schematic diagram of a heterogeneous network in which a tunnel is established between a mobile station and an eBTS according to an embodiment of the present invention;

FIG. 3 is a schematic diagram illustrating a handover procedure performed when a mobile station moves between a cellular network and a wireless LAN network according to an embodiment of the present invention;

FIG. 4 is a schematic diagram of a heterogeneous network in which a tunnel is established between a mobile station and an eBSC according to an embodiment of the present invention;

FIG. 5A illustrates a handover in a heterogeneous network in which a tunnel is established between a mobile station and an eBSC, performed when the mobile station moves from a cellular network to a wireless LAN network according to an embodiment of the invention;

FIG. 5B shows a call flow according to the handover of FIG. 5A;

FIG. 5C shows a protocol stack of a CDMA 2000 1x data service for the handover of FIG. 5A;

FIG. 6A shows a handover in a heterogeneous network in which a tunnel is established between a mobile station and an eBSC, performed when the mobile station moves from a wireless LAN network to a cellular network according to an embodiment of the present invention;

FIG. 6B shows a protocol stack for the handover of FIG. 6A;

FIG. 7A shows that an MSC performs a handover when a mobile station moves between a cellular network and a wireless LAN network according to an embodiment of the present invention;

FIG. 7B shows a call flow according to the handover performed when a mobile station which is provided with a voice service in a cellular region moves to a wireless LAN region according to an embodiment of the present invention;

FIG. 7C shows a call flow according to the handover performed when a mobile station moves from a wireless LAN region to a cellular region according to an embodiment of the present invention;

FIG. 8A shows that a PDSN performs a handover for the mobile station which moves between a cellular network and a wireless LAN network according to an embodiment of the present invention;

FIG. 8B shows a call flow of the handover performed when a mobile station which is provided with a data service in a wireless LAN region moves to a cellular region according to an embodiment of the present invention;

FIG. 8C shows a protocol stack for the handover performed when a mobile station which is provided with a data service in a wireless LAN region moves to a cellular region according to an embodiment of the present invention; and

FIG. 8D shows a protocol stack for the handover performed when a mobile station which is provided with a data service in a cellular region moves to a wireless LAN region according to an embodiment of the present invention.

Throughout the drawings, like reference numbers will be understood to refer to like elements, features and structures.

### DETAILED DESCRIPTION OF EXEMPLARY EMBODIMENTS

Exemplary embodiments of the present invention will now be described more fully with reference to the accompanying drawings. It should be understood however, that the following description is intended to be exemplary, not limiting, and various changes an modifications may by made to the embodiments described herein without departing from the scope and spirit of the invention.

Throughout this specification, the term heterogeneous network refers a network in which a cellular network and a different type network other than the cellular network are interworked with each other through a tunnel. In particular, as described herein, a CDMA2000 1x network (as the cellular network) and a wireless LAN (specified in EEE 802.11) are interworked as the heterogeneous network. That is, in this specification, a “different type network” is represented by the wireless LAN network, and a “heterogeneous network” is represented by a network in which the cellular network and the wireless LAN network are interworked. However, the different type network is not limited to wireless LAN networks. The different type network can also be represented by a Bluetooth network, a WiMax network specified in IEEE 802.16, and any other suitable network.

Throughout the specification, a “cellular region” refers to a region in which a mobile station can access the cellular network using a cellular frequency, and a “wireless LAN region” refers to a region in which a mobile station can access the wireless LAN network using a wireless LAN frequency.

The mobile station (MS) in the wireless LAN region can be provided with a cellular service using a wireless LAN frequency by using a tunnel connected to the cellular network. The mobile station accesses a base station system (BSS) of the cellular network in the cellular region, and accesses an access point (AP) in the wireless LAN region. Here, the cellular region and the wireless LAN region can overlap each other. Typically, the cellular region is identified by a region managed or covered by a base transceiver system (BTS), whereas the wireless LAN region is identified by a region managed or covered by an access point (AP). That is, different cellular regions are covered by different BTSs, and different wireless LAN regions are covered by different APs. Handover is performed while moving between different cellular regions, between different wireless LAN regions, or between the cellular region and the wireless LAN region. As described herein, the mobile station performs a handover between cellular networks in substantially the same way as the conventional cellular network.

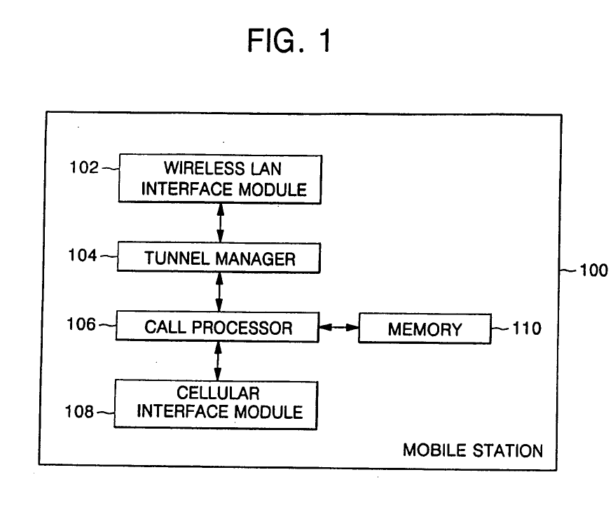

A mobile station according to an embodiment of the present invention should access the wireless LAN network in the wireless LAN region and so should have at least a wireless LAN interface function. The mobile station according to an embodiment of the present invention will be defined below with reference to FIG. 1.

FIG. 1 is a schematic block diagram of a mobile station according to an embodiment of the present invention.

Referring to FIG. 1, the mobile station 100 sets up a wireless link using a wireless LAN interface module 102 in a wireless LAN region and using a cellular frequency in a cellular region. The mobile station 100 can set up the wireless link in both regions and so perform the handover while moving between the two networks.

As shown in FIG. 1, the mobile station 100 comprises the wireless LAN interface module 102, a tunnel manager 104, a call processor 106, a cellular interface module 108, and a memory 110. The wireless LAN interface module 102 is allocated a radio resource from the wireless LAN network over a wireless LAN-dedicated frequency bandwidth to communicate with the wireless LAN network. The tunnel manager 104 establishes and manages a tunnel with the cellular network connected to the wireless LAN network using the radio resource provided from the wireless LAN network through the wireless LAN interface module 102. The call processor 106 accesses the cellular network through the tunnel established by the tunnel manager 104 to perform call processing. The cellular interface module 108 is allocated a radio resource from the cellular network over a cellular-dedicated frequency bandwidth to communicate with the cellular network. The memory 1 10 stores tunnel establishing information.

The mobile station 100 preferably performs a handover-related function. Here, the handover-related function includes, for example, a function for determining whether to handover, and a function for requesting the handover when the handover needs to be performed. Typically, the mobile station 100 determines that the handover needs to be performed when intensity of a signal transmitted through an existing path is lower than a threshold value. Of course, the handover can also be performed when the mobile station 100 can receive a signal which is higher in intensity than the signal transmitted through the existing path. The term “handover” refers to the procedure where the mobile station 100 is provided with a communication service through a different path instead of the existing path.

The term “mobile station” as described above, and as shown in FIG. 1, refers to a terminal device which can access both the cellular network and the wireless LAN network and perform the handover function. Thus, the mobile station 100 will not be described in any more detail.

Embodiments of the present invention relate to a handover in a heterogeneous network, in which two different type networks are interworked, through a tunnel established between the mobile station and the cellular network. The mobile station establishes a tunnel between a base transceiver station (BTS) of the cellular network or a base station controller (BSC) and itself, and is provided with a cellular service through the established tunnel. Here, the BTS or BSC which can establish a tunnel between the mobile station which accesses the BTS or BSC through the AP of the wireless LAN network and the BTS or BSC is referred to as an enhanced BTS (eBTS) or enhanced BSC (eBSC). The eBTS or eBSC performs a function for allocating radio resources using the cellular frequency like a typical BTS or BSC. The mobile station which accesses the eBTS or eBSC is a terminal device which is also allocated a wireless LAN frequency from the AP in the wireless LAN region.

Exemplary embodiments of the present invention will be explained below. A first embodiment exemplifies a handover in a heterogeneous network in which the tunnel is established between the mobile station and the eBTS. A second embodiment exemplifies a handover in a heterogeneous network in which the tunnel is established between the mobile station and the eBSC. Background technologies of the cellular network and the wireless LAN network which are not directly related to embodiments of the present invention will be omitted for clarity and conciseness.

A handover system and method in the heterogeneous network in which the tunnel is established between the mobile station and the eBTS will now be described.

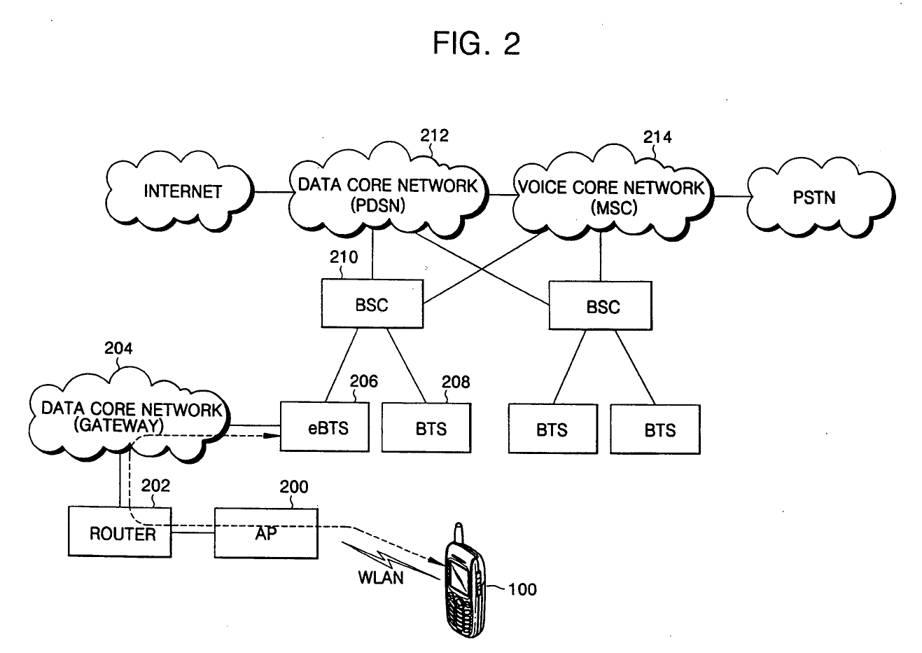

FIG. 2 is a schematic diagram of a heterogeneous network in which a tunnel is established between a mobile station and an eBTS according to an embodiment of the present invention.

The heterogeneous network of FIG. 2 comprises a mobile station 100, an access point (AP) 200, a router or switch (hereinafter, router) 202, a gateway 204, and an eBTS 206. The AP wirelessly communicates with the mobile station 100 using a wireless LAN frequency. The router 202 connects the AP 200 to an external network. The gateway 204 connects the AP 200 to an external network such as the Internet through the router 202. The eBTS 206 is connected to the gateway 204 via a wired network, forms a tunnel between the mobile station and the eBTS 206 through the wired network, and provides the mobile station 100 with a cellular service through the formed tunnel.

As shown in FIG. 2, the eBTS 206 is connected to a packet data switched network (PDSN) 212 or a mobile switching center (MSC) 214 through a BSC 210. The PDSN 212 is connected to the Internet to provide the mobile station 100 with a data communication. The MSC 214 is connected to a public switched telephone network (PSTN) to provide the mobile station 100 with a voice communication. The PDSN 212 and the MSC 214 perform switching functions to provide a data communication and a voice communication, respectively.

The eBTS 206 has a function for establishing and managing a wireless link with the mobile station 100 covered by the eBTS 206 using a cellular frequency and a function for performing a service for the mobile station 100 which accesses the eBTS 206 through a wireless LAN frequency. That is, the eBTS 206 can transmit data transmitted from the mobile station 100 connected through the tunnel in the wireless LAN region to the PDSN 212 or the MSC 214 through the BSC 210. Data and signaling transmission between the BSC 210 and the eBTS 206 are performed through an air interface specified in the standard (such as, the Abis interface) or an inter processor communication (IPC) of each network equipment manufacturer. The eBTS 206 receives cellular service data from the BSC 210 and transmits the cellular service data to the mobile station 100 through a pre-established tunnel. The eBTS 206 transmits the data received from the mobile station 100 to the BSC 210 through the Abis interface or discrete IPC.

The eBTS 206 operates in a similar way to other BTSs 208 so that the BSC 210 can recognize the eBTS 206 in substantially the same way as the other BTSs 208.

The procedure for establishing a tunnel between the mobile station 100 and the eBTS 206 in the heterogeneous network will now be described.

To establish the tunnel with the eBTS 206, the mobile station 100 first accesses the AP 200 to be allocated an IP address from the gateway 204 through, for example, a dynamic host configuration protocol (DHCP). Then, the mobile station 100 establishes the tunnel to the eBTS 206 using a tunnel technique such as a user datagram protocol (UDP), a generic routing encapsulation (GRE), and a GPRS transfer protocol (GTP).

In the case of establishing a UDP tunnel to the eBTS 206, the mobile station 100 transmits a message for requesting tunnel establishment to the eBTS 206 using an IP address and a UDP port of the eBTS 206 which are stored therein. The message may contain information which indicates an ID (IMSI, IP address, MAC address, and so on) of the mobile station 100, a user ID (such as, NAI), and a data type (CS signaling, CS data, PS signaling, PS data, and other information). The message is referred to as a “tunnel establishment request message”.

The eBTS 206 receives the tunnel establishment request message from the mobile station 100 and periodically transmits a message which contains system-related information such as a cell ID received from the BSC 210 through a source port number of the mobile station 100. The UDP tunnel is completely established between the mobile station 100 and the eBTS 206 by the above described procedure, and then the mobile station 100 and the eBTS 206 exchange necessary information using the UDP tunnel.

Alternatively, in case of establishing a GRE tunnel to the eBTS 206, the mobile station 100 transmits a message which contains an ID of the mobile station 100, a user ID, and desired options (such as, sequence number use, and encryption application) to the eBTS 206. When the eBTS 206 receives the message from the mobile station 100, the eBTS 206 allocates necessary options and transmits a GRE message to the mobile station 100 using the corresponding option. The mobile station 100 receives the GRE message, and then transmits a confirmation message to the eBTS 206 using the GRE message again, whereby the GRE tunnel is completely established between the mobile station 100 and the eBTS 206. Then, the mobile station 100 and the eBTS 206 exchange necessary information using the GRE tunnel.

In the exemplary heterogeneous network described above, the mobile station 100 may move from one network to another network of a different type. At this time, the handover should be performed. The handover procedure includes a procedure for detecting the mobile station moving from an existing region to another region and a procedure for establishing a new communication path for communication after moving to another region. Here, the BSC determines whether to perform the handover and performs a follow-up procedure based on the determination result. However, the handover request is preferably performed by the mobile station.

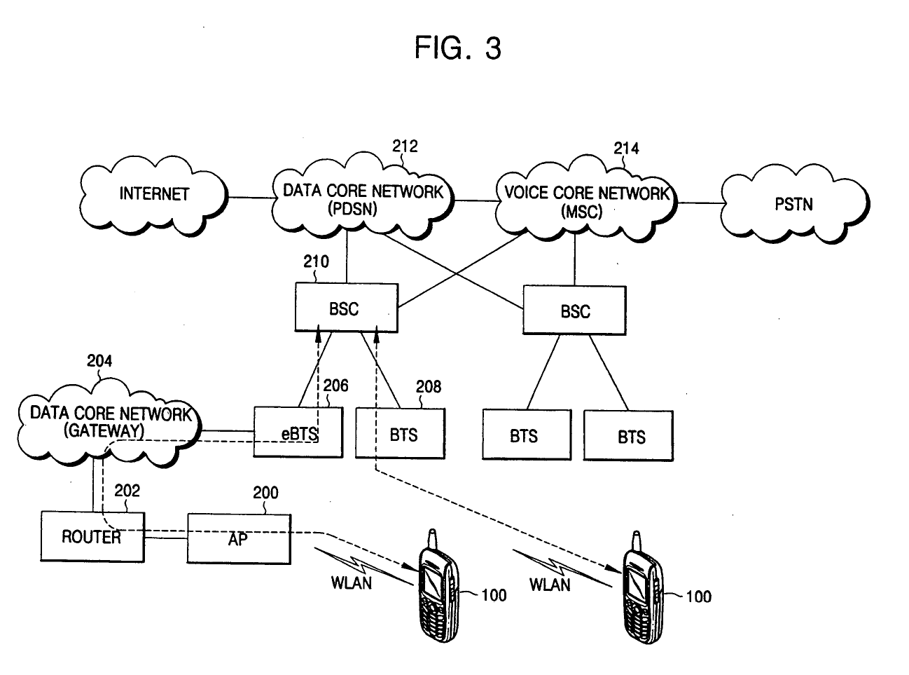

FIG. 3 is a schematic diagram illustrating a handover procedure performed when a mobile station moves between a cellular network and a wireless LAN network.

In FIG. 3, the handover is performed when the mobile station 100 moves from the cellular region to the wireless LAN region. The handover is performed in a similar way to a typical handover performed between the BTSs using the BSC 210 as an anchor except that the tunnel establishing procedure is performed to set up a new communication path after the handover. This is because the BSC 210 preferably communicates with the eBTS 206 in substantially the same way as the BTS 208 in the heterogeneous network in which the tunnel is established between the mobile station 100 and the eBTS 206.

That is, the handover in the heterogeneous network in which the tunnel is established between the mobile station 100 and the eBTS 206 can be processed in a similar way to the typical handover of the cellular network.

An exemplary handover in the heterogeneous network in which the tunnel is established between the mobile station 100 and the eBSC 400 will now be described. First, tunnel establishment between the mobile station 100 and the eBSC 400 will be described.

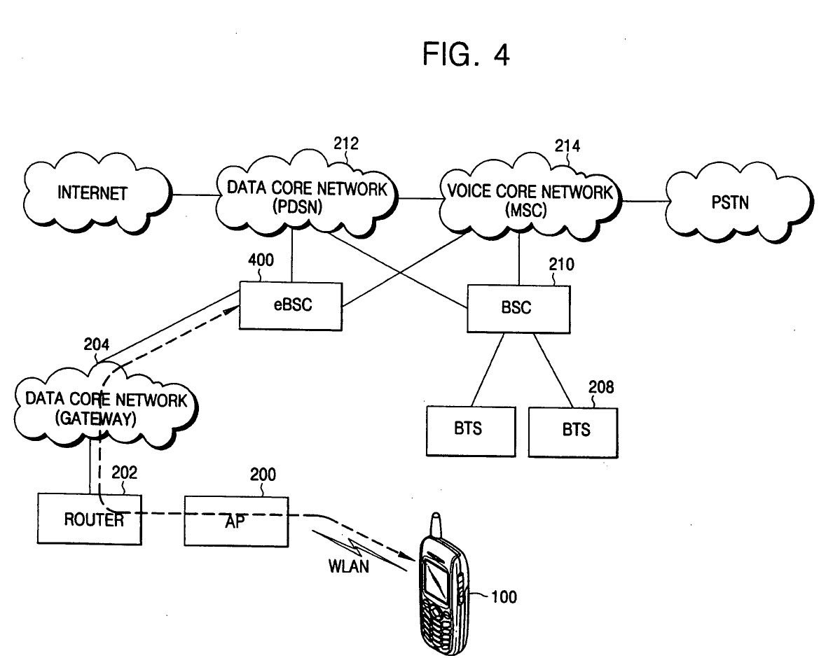

FIG. 4 is a schematic diagram of a heterogeneous network in which a tunnel is established between a mobile station and an eBSC.

In FIG. 4, the eBSC 400 transmits data transmitted from the mobile station 100 connected thereto through the tunnel to a PDSN 212 or MSC 214. The eBSC 400 performs a function for controlling base transceiver stations (including eBTS and BTS) managed or covered by the eBSC 400, and performs a cellular communication service for the mobile station 100 connected through the wireless LAN. That is, the eBSC 400 has a function for establishing the tunnel with the mobile station 100 connected through the wireless LAN as well as a typical BSC function. The eBSC 400 determines whether to perform the handover and performs a follow-up procedure based on the determination.

Other components of FIG. 4 which have not been described above perform similar operation to those shown in FIG. 2. However, it should be noted that the eBTS 206 preferably does not need to be arranged when an eBSC 400 is provided.

Tunnel establishment between the mobile station 100 and the eBSC 400 will now be described.

The mobile station 100 accesses the AP 200 to be allocated an IP address from the gateway 204 by, for example, DHCP. Then, the mobile station 100 establishes a tunnel to the eBSC 100 using a tunneling technique such as UDP or GRE.

When establishing a tunnel with the eBSC 400 using UDP, the mobile station 100 transmits a tunnel establishment request message to the eBSC 400 using an IP address and a UDP port of the eBSC 400 which are stored in the mobile station 100. The eBSC 400 receives the tunnel establishment request message from the mobile station 100, and periodically transmits a message containing BSC-related information such as a cell ID through a source portion number of the corresponding mobile station 100, whereby the UDP tunnel is completely established between the mobile station 100 and the eBSC 400.

Alternatively, when establishing atunnel with the eBSC 400 using the GRE, the mobile station 100 transmits to the eBSC 400 a message which contains an ID of the mobile station 100, a user ID, and desired options (sequence number use, encryption application). The eBSC 400 allocates necessary options and transmits the GRE message using the corresponding options. The mobile station 100 receives the GRE message and then transmits a confirmation message to the eBSC 400 using the GRE message, thereby establishing the GRE tunnel.

An exemplary handover in the heterogeneous network in which the tunnel is established between the mobile station 100 and the eBSC 40 will now be described.

The handover in the heterogeneous network in which the tunnel is established between the mobile station 100 and the eBSC 40 can include an inter BSC handover, a handover performed by the MSC 214, and a handover performed by the PDSN 212.

First, the inter BSC handover will be described.

The inter BSC handover includes a handover performed when the mobile station 100 moves from the cellular network to the wireless LAN network and a handover performed when the mobile station 100 moves from the wireless LAN network to the cellular network.

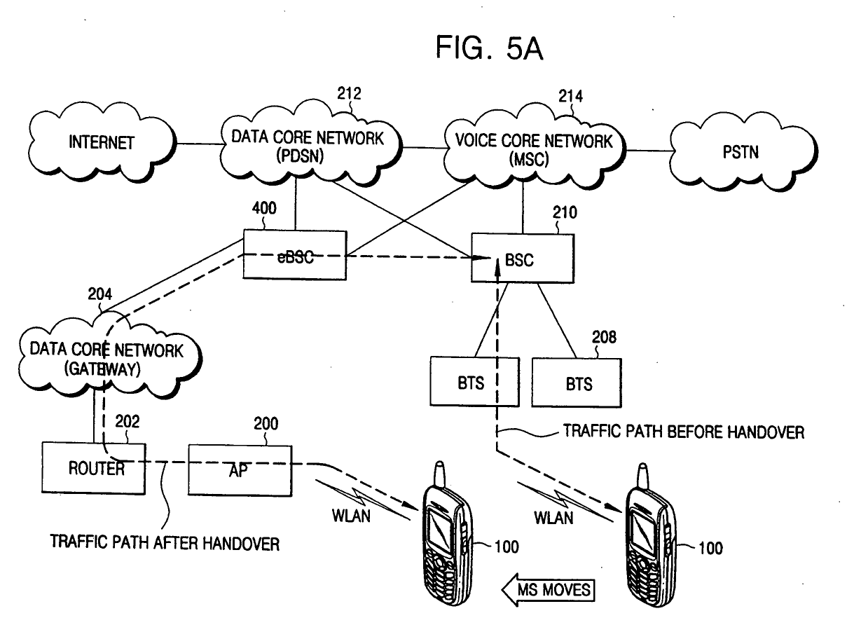

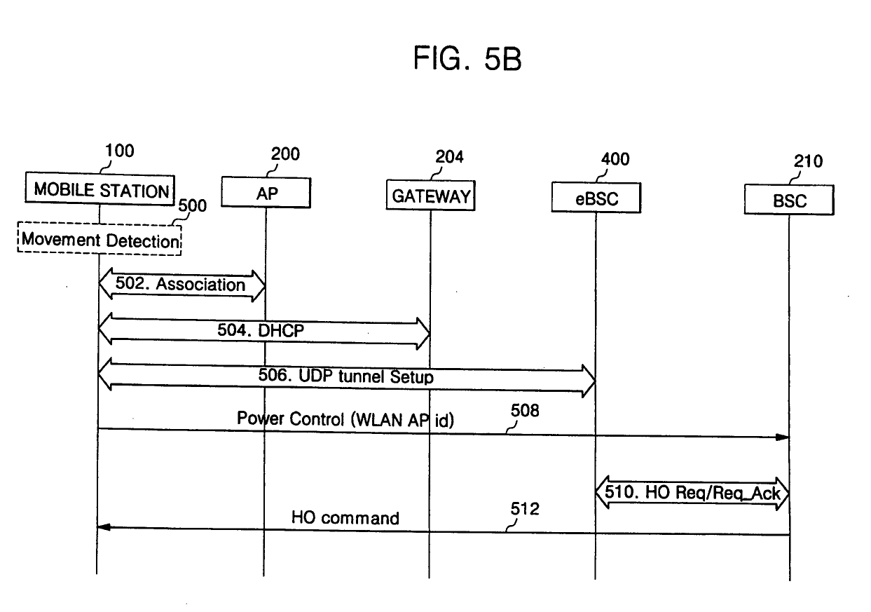

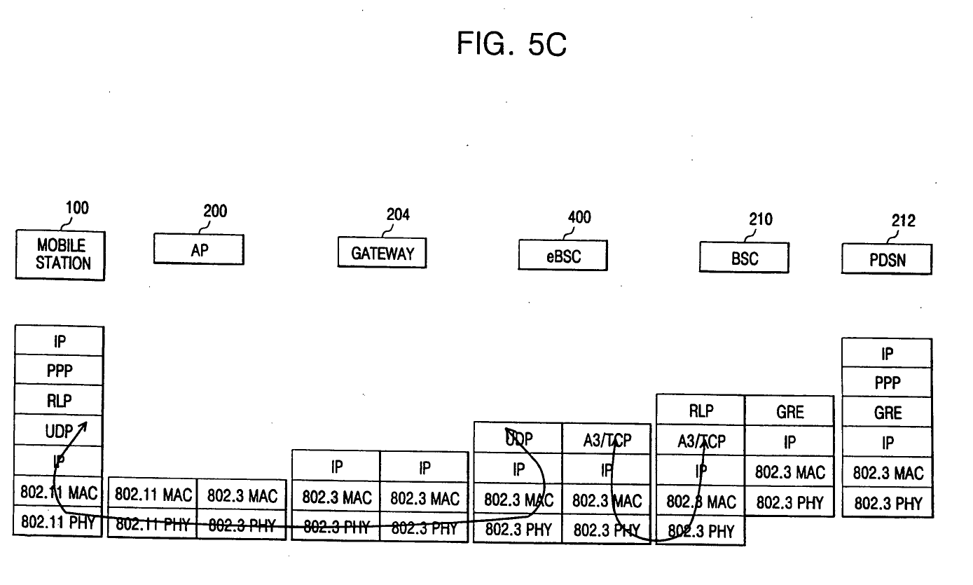

FIG. 5A shows a handover in a heterogeneous network in which a tunnel is established between the mobile station 100 and the eBSC 400, which is performed when the mobile station 100 moves from the cellular network to the wireless LAN network.

As shown in FIG. 5A, the mobile station 100, which is provided with a communication service from the cellular network through a traffic path connected through the BTS 208 and the BSC 210 in the cellular network region, moves to the wireless LAN region to be provided with a communication service through a new traffic path connected through the AP 200, the router 202, the gateway 204, the eBSC 400, and the BSC 210. At this time, the mobile station 100 should perform tunnel establishment with the eBSC 400 to establish the new traffic path.

In the handover of FIG. 5A, the BSC 210 which operates in the existing cellular network serves as an anchor station. The tunnel is established between the mobile station 100 and the eBSC 400, and the BSC 210 regards that the eBSC 400 operates in the same way as other BSCs. Thus, a call flow of the inter BSC handover is similar to that specified in the existing cellular standard.

FIG. 5B shows a call flow of the handover shown in FIG. 5A.

The mobile station 100 detects a change of a region to which it belongs and regards it as a handover starting time point (step 500). At this time, the mobile station 100 detects the change of its region by recognizing that intensity of a signal received from the BTS 208 is weaker. Then, the mobile station 100 sets up connection (association) for the AP 200 (step 502), obtains an ID address through the DHCP for the gateway 204 (step 504), and establishes the tunnel for the eBSC 400 to be newly connected (step 506), thereby establishing a path to be used to transmit data to a handover call. Here, the reason why the tunnel establishing procedure is performed while setting up the path for the handover is that the handover is performed in the heterogeneous network in which two different type networks are interworked by the tunnel. When the handover tunnel is established, the mobile station 100 transmits a handover request message to the previous BSC 210 (step 508). The handover request message may be transmitted using a power control message. The handover request message contains information about the eBSC 400 to which a new traffic path is set up. Then, the previous BSC (that is, BSC 210) and the new BSC (that is, eBSC 400) exchange the handover request message and a response message (step 510) to thereby complete the handover. After the handover, data transmission between the BSC 210 and the eBSC 400 is preferably performed using A7 protocol which is the CDMA 2000 1x standard.

FIG. 5C shows a protocol stack of the CDMA 2000 1x data service for the handover of FIG. 5A.

Referring to FIG. 5C, it can be seen that an inter BSC handover path is set up between the BSC 210 which was used by the mobile station 100 for an access to the cellular network and the eBSC 400 which is used by the mobile station 100 for an access to the wireless LAN network so that traffic can be transmitted. In FIG. 5C, it is assumed that the UDP tunnel is established between the mobile station 100 and the eBSC 400.

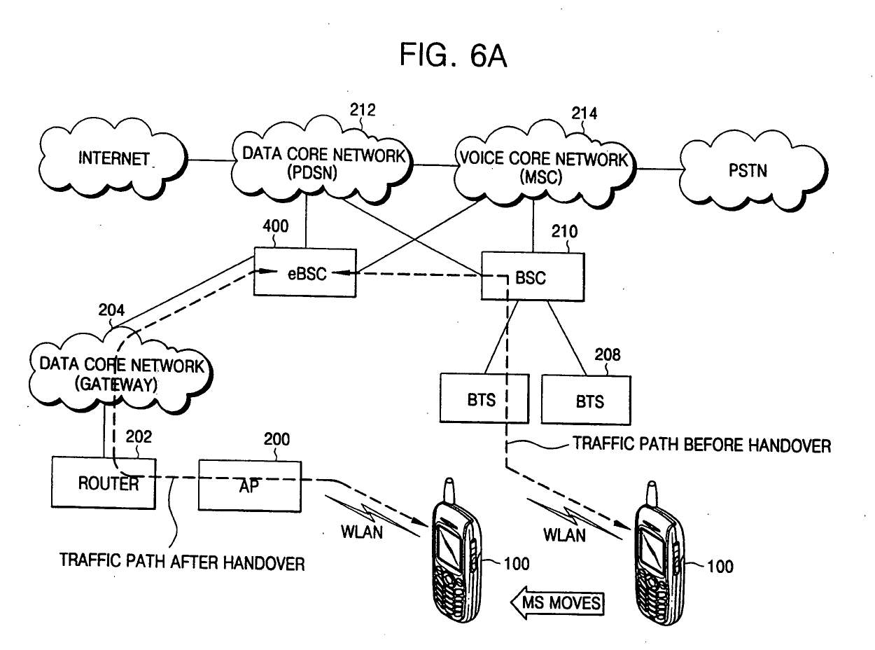

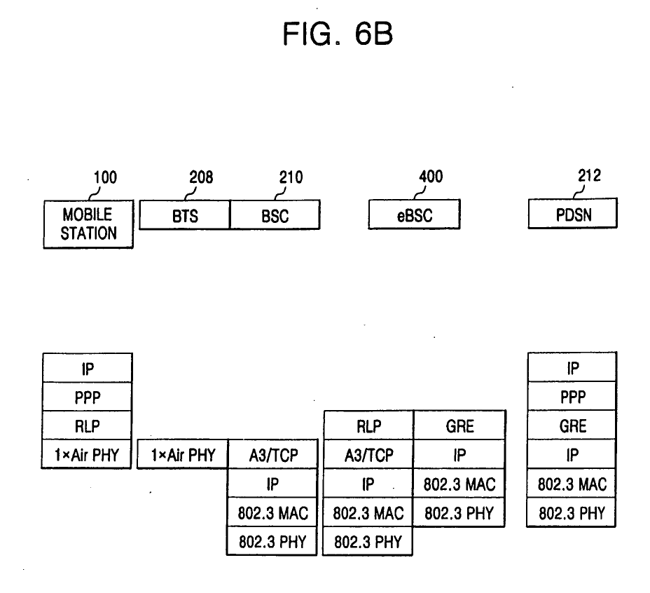

FIG. 6A shows a handover in a heterogeneous network in which the tunnel is established between a mobile station and an eBSC, which is performed when the mobile station moves from the wireless LAN network to the cellular network.

As shown in FIG. 6A, the mobile station 100 which is connected to the cellular network through the AP 200, the router 202, the gateway 204, and the eBSC 400 in the wireless LAN region to be provided with a communication service, moves to the cellular region to be provided with a communication service through a new traffic path established between the BTS 208, the BSC 210 and the eBSC 400.

In FIG. 6A, the eBSC 400 serves as an anchor station to perform the inter BSC handover.

FIG. 6B shows a protocol stack for the handover of FIG. 6A.

An exemplary handover performed by the MSC 214 will be explained below.

An exemplary handover performed by the MSC 214 is performed when the mobile station 100 is connected to the PSTN through the MSC 214 to be provided with a voice service.

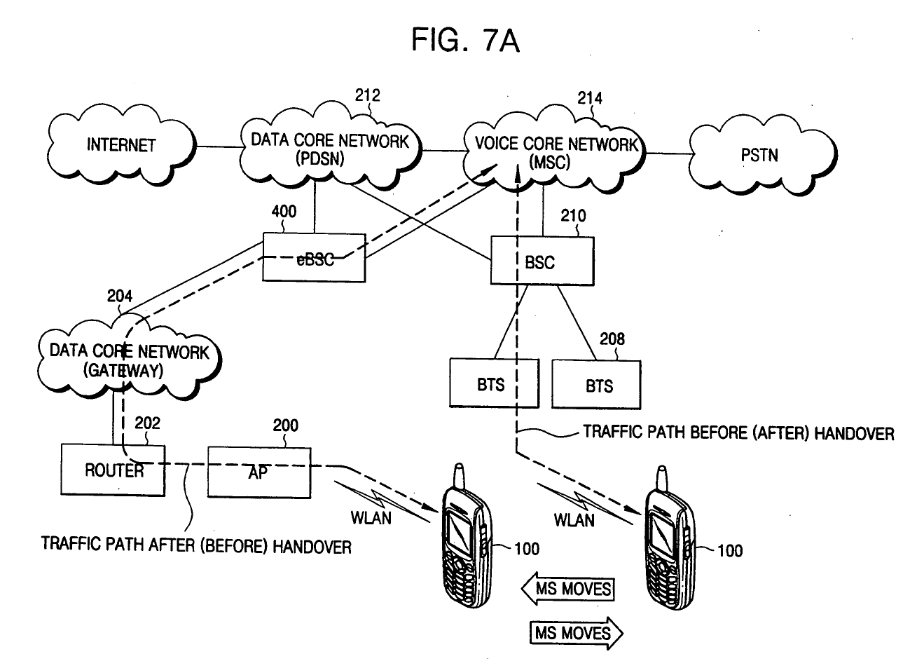

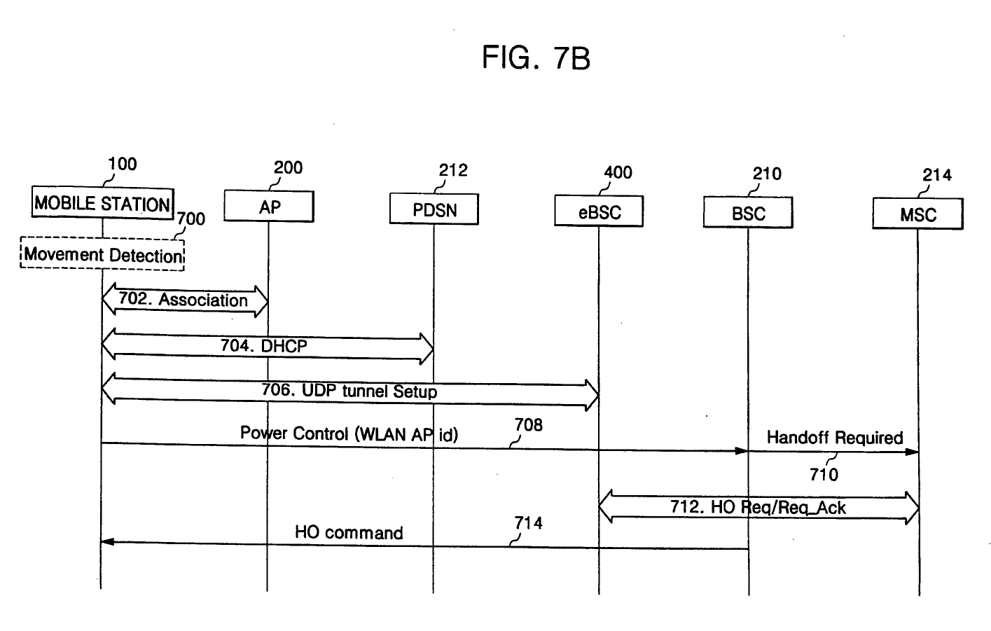

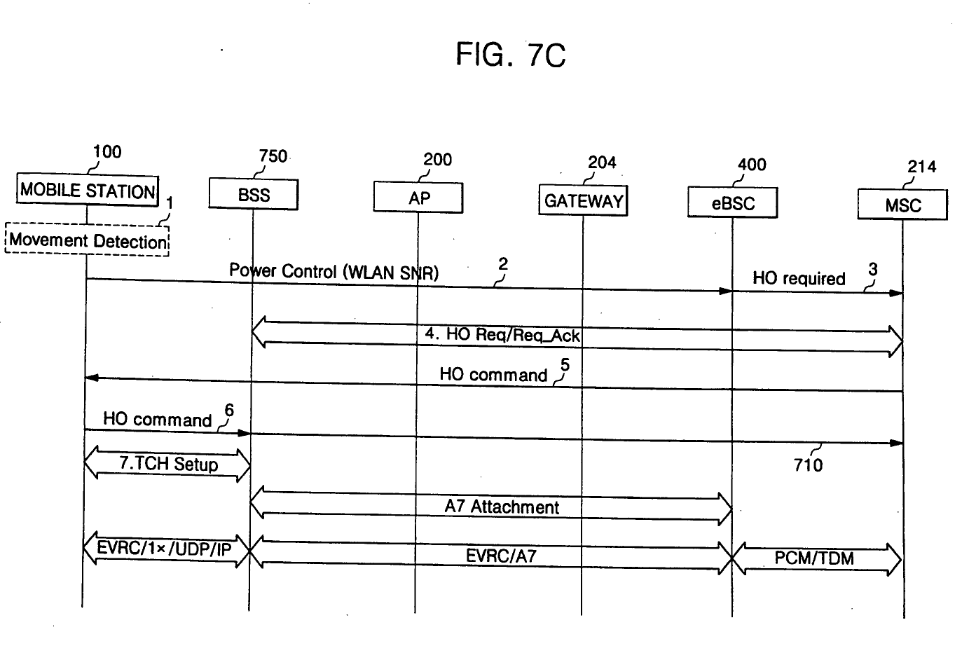

FIG. 7A shows that the MSC performs the handover when the mobile station 100 moves between the cellular network and the wireless LAN network.

As shown in FIG. 7A, the mobile station 100 can be handed over between a path connected to the MSC 214 through the eBSC 400 and a path connected to the MSC 214 through the BSC 210.

The handover of FIG. 7A will be explained below in detail with reference to FIGS. 7B and 7C.

FIG. 7B shows a call flow of the handover performed when the mobile station which is provided with a voice service in the cellular region moves to the wireless LAN region.

The mobile station 100 which is connected to the BSC 210 to be provided with a communication service detects that a signal received from the BTS 208 becomes weak to recognize a change of its region (step 700) and so requests a handover from the eBSC 400 to move to the cellular region. The handover request procedure includes a procedure (step 702) for establishing a connection with the AP 200, a procedure (step 704) for being allocated an IP address from the gateway 204, and a procedure (step 706) for establishing a tunnel with the eBSC 400. When the tunnel with the eBSC 400 is established, the mobile station 100 transmits to the BSC 210 a handover request message which requests a handover to the eBSC 400 using a power control message (step 708). The handover request message is transmitted to the MSC 214 through the BSC 210. The MSC 214 receives the handover request message and then exchanges the handover request message and a response message with the eBSC 400 which is to be connected to the mobile station 100 after the handover. When the response message for approving the handover is received from the eBSC 400, the MSC 214 instructs the mobile station 100 to transmit data through a new traffic path established by the handover.

FIG. 7C shows an exemplary call flow according to the handover performed when the mobile station moves from the wireless LAN region to the cellular region.

The handover performed by the PDSN 212 will now be described. The handover performed by the PDSN 212 is performed while the mobile station 100 is provided with a data service. Here, a base station system (BSS) 750 represents the BTS 208 or the BSC 210.

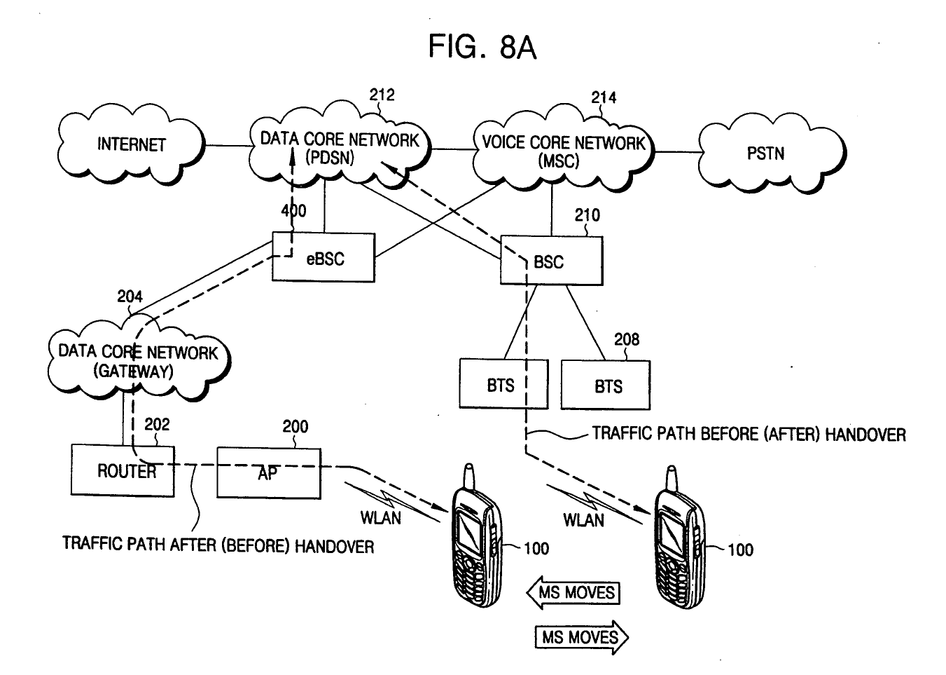

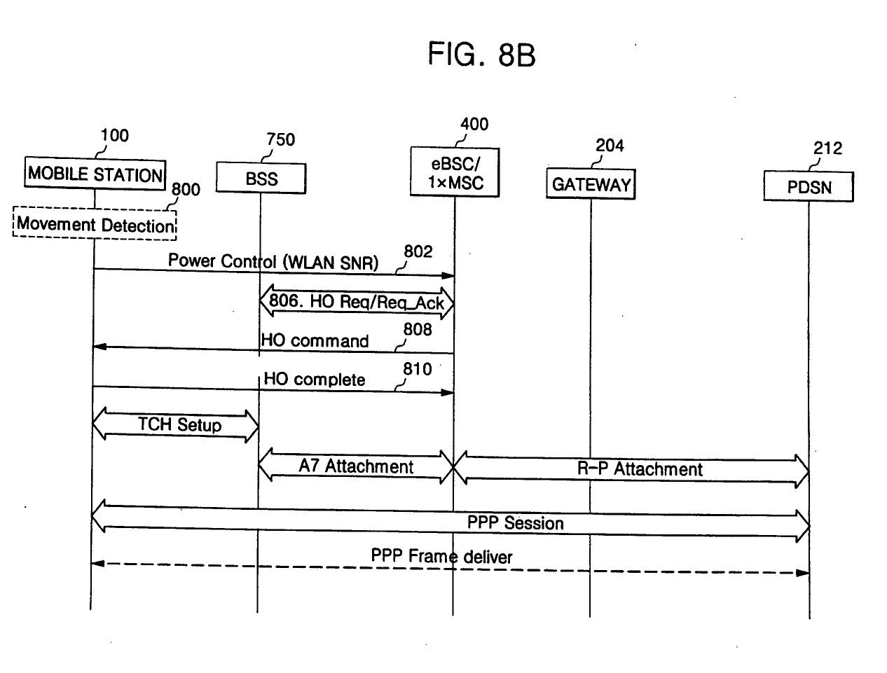

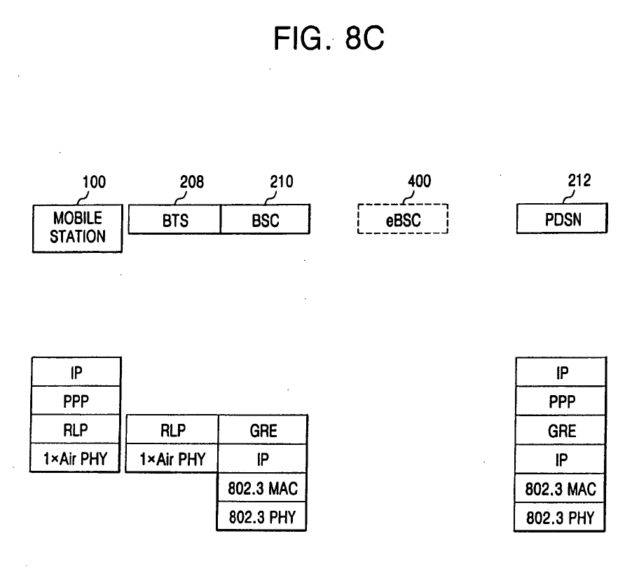

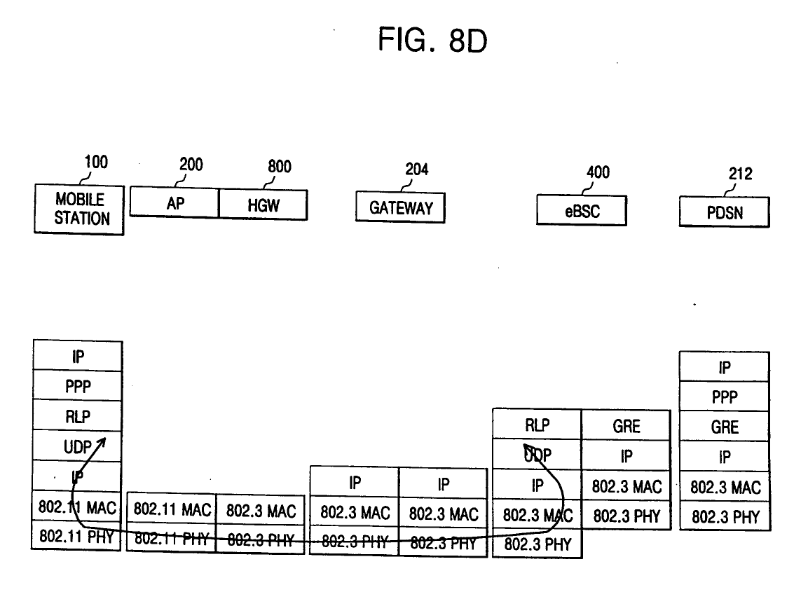

FIG. 8A shows that the PDSN performs the handover when the mobile station moves between the cellular network and the wireless LAN network.

The mobile station 100 may be handed over between a path connected to the PDSN 212 through the eBSC 400 and a path connected to the PDSN through the BSC 210.

FIG. 8B shows a call flow of the handover performed when the mobile station which is provided with a data service in the wireless LAN region moves to the cellular region.

The mobile station 100 detects that a signal received from the AP 200 becomes weak to recognize that the handover needs to be performed, whereby the handover begins. The handover procedure of FIG. 8B is preferably performed in a similar way to the inter BSC handover procedure.

FIG. 8C shows a protocol stack for the handover performed when the mobile station which is provided with a data service in the wireless LAN region moves to the cellular region.

As shown in FIG. 8C, when the handover of from the wireless LAN region to the cellular region is performed by the PDSN 212, since the PDSN 212 performs a traffic path directly with the BSC 212 after the handover, the eBSC 400 is excluded from the traffic path.

FIG. 8D shows a protocol stack for the handover performed when the mobile station which is provided with a data service in the cellular region moves to the wireless LAN region.

In FIG. 8D, a HGW 800 is a home gateway. A description of the HGW 800 will be omitted for clarity and conciseness. In FIG. 8D, it is assumed that the UDP tunnel is established between the mobile station 100 and the eBSC 400.

In this case, the BSC 210 is excluded from the traffic path after the handover.

Meanwhile, it should be understood that a mobile station which does not have a cellular interface function but has only a wireless LAN interface function can access the network in the wireless LAN region. However, this type of mobile station can not access the network in the cellular region. Thus, such a mobile station only performs a handover service when it moves from one wireless LAN region to another wireless LAN region. Such a mobile station can be provided the handover service when it moves between different wireless LAN regions in the network in which a cellular service is provided in the wireless LAN region.

It should be appreciated that embodiments of the present invention are not limited to the heterogeneous network in which the cellular network and the wireless LAN network are interworked and can be applied to a heterogeneous network in which another network other than the wireless LAN network is interworked with the cellular network.

As described above, the handover system and method according to embodiments of the present invention can guarantee mobility of a mobile station in the heterogeneous network.

While the present invention has been described with reference to exemplary embodiments thereof, it will be understood by those skilled in the art that various changes in form and detail may be made therein without departing from the scope of the present invention as defined by the following claims.

What is claimed is:

1. A handover system in a heterogeneous network, comprising:
a first network for providing a radio resource using a first radio frequency bandwidth;
a first apparatus of a cellular network connected to the first network through a wired network; and
a mobile station for accessing the cellular network through a tunnel established with the first apparatus using the radio resource provided from the first network or accessing the cellular network using a radio resource provided from the cellular network, setting up a new path by a handover when the handover is needed, and accessing the cellular network through the new path.

2. The system of claim 1, wherein the mobile station determines that the handover is needed when intensity of a received signal is lower than a predetermined threshold.

3. The system of claim 1, wherein the mobile station establishes a tunnel with a second apparatus of the cellular network other than the first apparatus for setting up the new path which is allocated the radio resource from the first network.

4. The system of claim 3, wherein the mobile station releases an existing path with the first apparatus after the new path with the second apparatus is set up.

5. The system of claim 3, wherein the tunnel is established using one of a user datagram protocol (UDP), a generic routing encapsulation (GRE), and a global packet radio service (GPRS) transfer protocol (GTP).

6. The system of claim 5, wherein the mobile station transmits information about the existing path with the first apparatus to the second apparatus when the new path with the second apparatus is established.

7. The system of claim 1, wherein the mobile station transmits to the first apparatus a first message which notifies that data will be transmitted through the new path before transmitting data through the new path.

8. The system of claim 7, wherein the first message is transmitted using a power control message.

9. The system of claim 7, wherein the first message contains information of the new path.

10. The system of claim 1, wherein the first apparatus is one of an enhanced base transceiver system (eBTS) and an enhanced base station controller (eBSC).

11. The system of claim 1, wherein the first network is one of an IEEE 802.11 wireless LAN network, a Bluetooth network, and an IEEE 802.16 WiMax network.

12. A handover system in a heterogeneous network in which a cellular network is interworked with a first network through a tunnel established between a mobile station and an eBTS of the cellular network, the handover system comprising:
a mobile station for requesting a handover when it is determined that the handover is needed; and
an eBTS for, setting up a new path by establishing the tunnel with the mobile station when receiving a tunnel establishment request for the handover from the mobile station, , and transmitting/receiving data to/from the mobile station through the new path.

13. The system of claim 12, wherein the eBTS transmits data received from the mobile station to a base station controller (BSC) to which the mobile station is connected before the handover and transmits the data received from the BSC to the mobile station.

14. The system of claim 12, wherein the eBTS receives information about the BSC from the mobile station when the new path is set up.

15. A handover system in a heterogeneous network in which a cellular network is interworked with a first network through a tunnel established between a mobile station and an eBSC of the cellular network, the handover system comprising:
a mobile station for requesting a handover when it is determined that the handover is needed; and
an eBSC for, setting up a new path by establishing the tunnel with the mobile station when receiving a tunnel establishment request for the handover from the mobile station, and transmitting/receiving data to/from the mobile station through the new path.

16. The system of claim 15, wherein the eBSC transmits data received from the mobile station to a BSC to which the mobile station is connected before the handover and transmits the data received from the BSC to the mobile station.

17. The system of claim 16, wherein the eBSC receives information about the BSC from the mobile station when the new path is set up.

18. A handover method in a heterogeneous network in which a cellular network is connected with a first network through a tunnel, the method comprising:
determining, at a mobile station, whether to perform a handover;
establishing a tunnel connected to the cellular network through the first network to set up a new path used to transmit data after the handover; and
transmitting or receiving data to or from the cellular network through the set up new path.

19. The method of claim 18, further comprising releasing a previous path used before the handover.

20. A handover method in a heterogeneous network in which a cellular network is interworked with a first network through a tunnel established between a mobile station and an eBTS of the cellular network, the method comprising:
receiving, at the eBTS, a new path establishment request for a handover from the. mobile station;
setting up a new path by establishing the tunnel with the mobile station; and
transmitting or receiving data to or from the mobile station through the new path.

21. A handover method in a heterogeneous network in which a cellular network is interworked with a first network through a tunnel established between a mobile station and an eBSC of the cellular network, the handover method comprising:
receiving, at the eBSC, a new path establishment request for a handover from the mobile station;
setting up a new path by establishing the tunnel with the mobile station; and
transmitting or receiving data to or from the mobile station through the new path.
